(19) United States
(12) Patent Application Publication
(10) Pub. No.: US 2018/0115662 A1
(43) Pub. Date: Apr. 26, 2018

(54) HUMAN READABLE SENTENCES USED TO REPRESENT COMPLEX COLOR CHANGES IN A PRINT DRIVER

(71) Applicant: Xerox Corporation, NORWALK, CT (US)

(72) Inventor: Jeremy Griffith, East Rochester, NY (US)

(73) Assignee: Xerox Corporation, NORWALK, CT (US)

(21) Appl. No.: 15/299,730

(22) Filed: Oct. 21, 2016

(51) Int. Cl. H04N 1/00; G06F 3/0482; G06F 3/0481; G06F 17/28; G06F 3/0484; H04N 1/60

(52) U.S. Cl. CPC H04N 1/00424; G06F 3/0482; G06F 3/04817; H04N 2201/0094; G06F 3/04847; H04N 1/60; G06F 17/28

(57) ABSTRACT

A wizard menu option is provided to begin a natural language wizard. A first wizard question page is provided that displays only a menu of colors. A second wizard question page is provided that displays only a menu of change magnitude/orientation phrases. A third wizard question page is provided that displays only a menu of color characteristic terms. A natural language sentence is created by combining a selected color, a selected change magnitude/orientation phrase, and a selected color characteristic term. In response to the natural language sentence, a color item is altered by changing locations of the image that have the selected color according to the selected change magnitude and change orientation phrase, and the selected color characteristic term.

### BACKGROUND

Systems and methods herein generally relate to obtaining user color refinements and more particularly to human readable sentences that are used to represent complex color changes in a print driver.

Print drivers are increasingly providing users with highly sophisticated options to dramatically increase the quality of items that are output, through printing or display. However, this comes at the cost of potential user confusion and lack of familiarity with different features that a print driver may offer. In view of this, many systems have been developed to help the user understand the options that are available to them, and to make the selection of such options as easy and user-friendly as possible.

Some user interface limitations inhibited the creation of a more intuitive experience. For example, some people have difficulty learning the print driver interface, fine tuning the affected color, navigating the various dropdowns, etc.

### SUMMARY

Exemplary methods herein provide an electronic display image (e.g., from a processor to a display device) having a wizard menu option that begins a natural language wizard. For example, the wizard menu option can appear in a document printing or display menu (e.g., print driver menu). The natural language wizard generates a natural language sentence indicating an intended color change to a color item that will be output, by combining responses to wizard question pages. The wizard menu option can be a menu option to create the natural language sentence, or a menu option to edit a previously created natural language sentence.

Such methods provide, from the processor to the display device, an electronic display image containing one of the wizard question pages, in response to selection of the wizard menu option. This wizard question page only displays a menu of colors. Then, in response to selection of an expansion option for a color from the menu of colors, the processor can optionally create a second modified menu of colors by expanding the first menu of colors to include sub-colors of the expanded color, in addition to color choices provided within the first menu of colors. Thus, in these methods the processor can provide to the display device, an electronic display image having a second wizard question page that only displays the modified menu of colors, in response to selection of the expanded color from the first menu of colors.

Also, in methods herein the processor can supply to the display device, an electronic display image having a third wizard question page (in response to selection of the selected color from the first or second menu of colors). This third wizard question page only displays a menu of change magnitude and change orientation phrases (e.g., more, slightly more, less, etc.).

Then, with such methods, the processor provides to the display device, an electronic display image having another (e.g., a fourth) wizard question page in response to selection of a change magnitude and change orientation phrase from the menu of change magnitude and change orientation phrases. This fourth wizard question page only displays a menu of color characteristic terms.

This allows the processor to create (in response to selection of a color characteristic term from the menu of color characteristic terms) the natural language sentence by combining the selected color, the change magnitude and change orientation phrase, and the color characteristic term. As a result of the natural language sentence being created, in these methods the processor alters the output (e.g., printing, display, etc.) of a color item by changing locations (e.g., pixels) of the color item that have the selected color, and such color item locations are changed according to the selected change magnitude and change orientation phrase, and the color characteristic term.

The first menu of colors and the modified menu of colors (if provided) also include displayed text asking the user what color to change; the menu of change magnitude and change orientation phrases includes displayed text asking the user how much change to make; and the menu of color characteristic terms includes displayed text asking the user what type of change to make. Additionally, the first menu of colors and the modified menu of colors (if provided) include icons of different colors, the menu of change magnitude and change orientation phrases includes icons of change and orientation, and the menu of color characteristic terms includes icons for types of changes. Further, all such menus, the first menu of colors, the modified menu of colors, the menu of change magnitude and change orientation phrases, and the menu of change magnitude and change orientation phrases include back and cancel buttons.

Devices and systems herein include, among other elements and components, a processor, a display device electrically connected to the processor (e.g., a user interface having an electronic display, and user input devices and features (touch screen, mouse, buttons, etc.)), a printer electrically connected to the processor, etc. The processor provides, to the display device, an electronic display image having a wizard menu option to begin a natural language wizard. The natural language wizard generates a natural language sentence indicating an intended color change by combining responses to wizard question pages.

The processor provides, to the display device, an electronic display image having a first wizard question page, in response to selection of the wizard menu option. The first wizard question page only displays a first menu of colors. The processor creates, in response to selection of an expanded color from the first menu of colors, a second modified menu of colors by expanding the first menu of colors to include sub-colors of the expanded color in addition to color choices provided within the first menu of colors. Also, the processor provides, to the display device, an electronic display image having a second wizard question page, in response to selection of the expanded color from the first menu of color. The second wizard question page only displays the modified menu of colors.

Additionally, the processor provides, to the display device, an electronic display image having a third wizard question page in response to selection of a selected color from the modified menu of colors. The third wizard question page only displays a menu of change magnitude and change orientation phrases. The processor further provides, to the display device, an electronic display image having a fourth wizard question page in response to selection of a change magnitude and change orientation phrase from the menu of change magnitude and change orientation phrases. The fourth wizard question page only displays a menu of color characteristic terms.

In turn, the processor creates, in response to selection of a color characteristic term from the menu of color characteristic terms, the natural language sentence by combining the selected color, the change magnitude and change orientation phrase, and the color characteristic term. The processor alters, in response to the natural language sentence, outputting (e.g., printing, display, etc.) of a color item performed by the printer by changing pixels of the color item that have the selected color according to the change magnitude and change orientation phrase, and the color characteristic term.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a flow diagram of various methods herein;

FIGS. 2-9 are schematic diagrams of electronic display images produced by devices and methods herein;

FIG. 10 is a schematic diagram illustrating systems herein; and

FIGS. 11 and 12 are schematic diagrams illustrating devices herein.

### DETAILED DESCRIPTION

As mentioned above, increases in print driver sophistication have come at the cost of potential user confusion and lack of familiarity with different features that a print driver may offer. Therefore, the systems and methods herein provide a printer driver presentation that enables novice users to create human readable sentences that describe complex color changes. These methods and devices enable the creation and management of multiple sentences, each of which represents a separate complex color change. This allows the user to understand what changes will be applied to their document by providing an ordered list of human readable sentences, and a set of thumbnails that demonstrate the color changes. Such methods and devices logically progress the user, step by step, through the process of creating or editing a natural language sentence. The user interface displays real-time visualization of the sentence as it is being created or edited, and the user interface for selecting a color to change is allows the user to easily expand a basic color into more refined options.

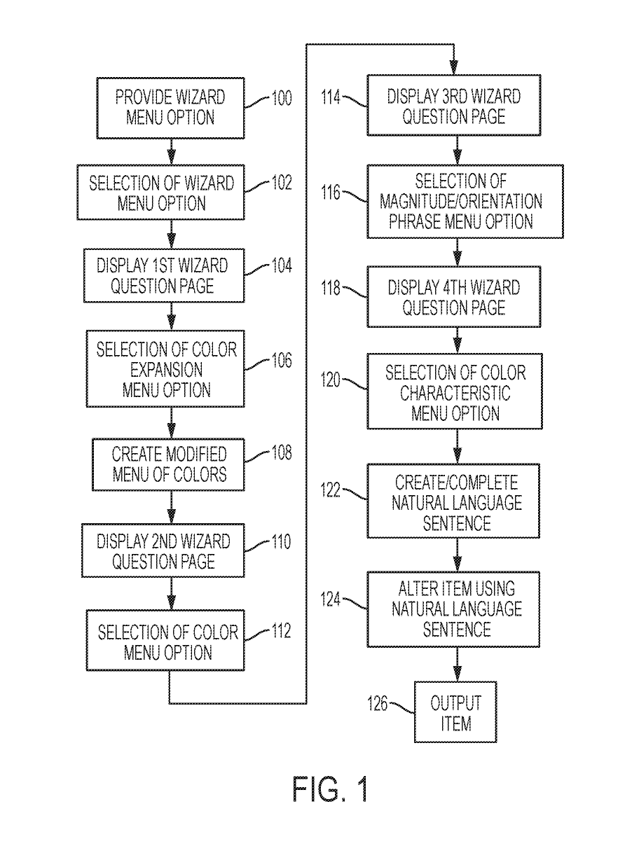

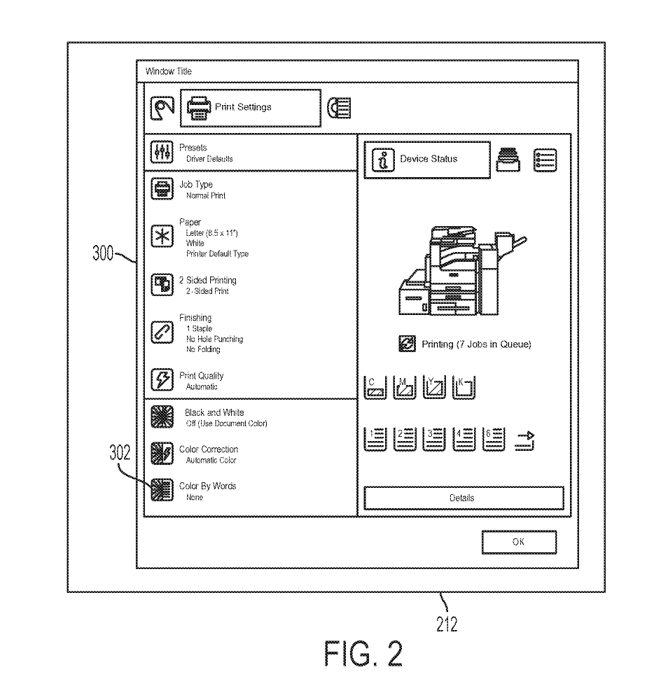

FIG. 1 is flowchart illustrating exemplary methods herein. In item 100, these methods automatically provide an electronic display image (e.g., from a processor to a display device) having a wizard menu option that begins a natural language wizard. For example, as shown in FIG. 2, the wizard menu option 302 (which is labeled “Color By Words” in FIG. 2) can appear in a document printing or display menu (e.g., print settings menu 300 of a print driver) that is presented on a human-readable display device, such as a touch screen graphic user interface device 212.

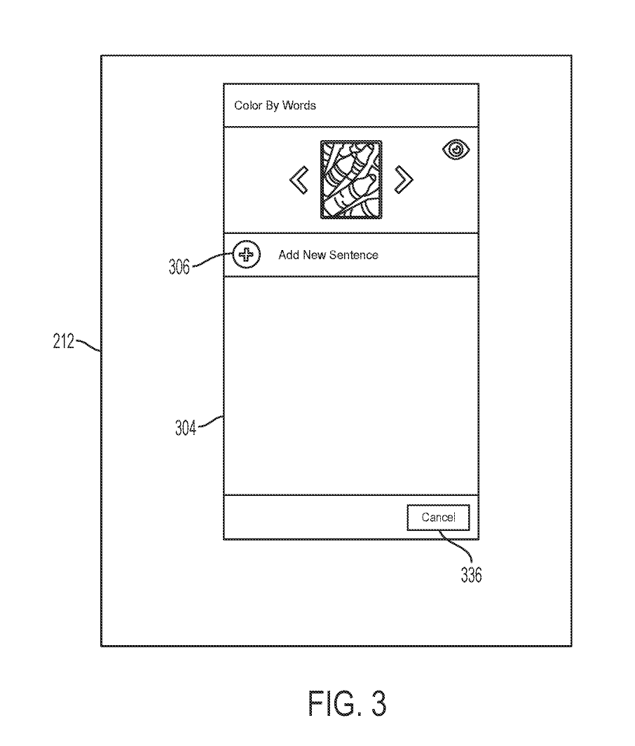

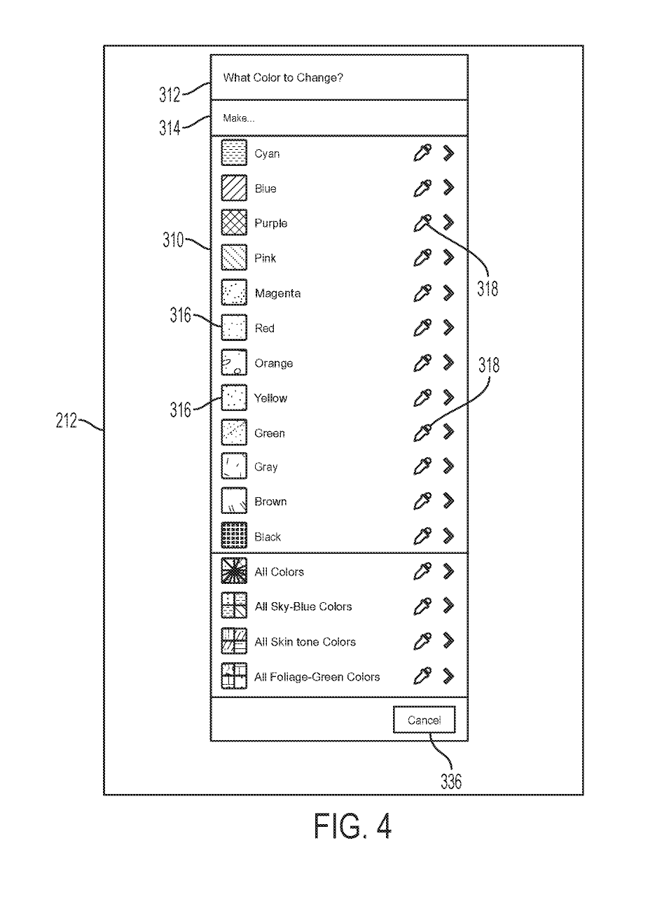

The print settings menu 300 can be displayed during the process of obtaining user output preferences when a color item (e.g., image, document, etc.) is being output (e.g., printed, displayed, etc.). The natural language wizard generates a natural language sentence indicating an intended color change to a color item that will be output, by combining responses to wizard question pages that the user is walked through, in an order that generates a natural language sentence (shown in FIGS. 4-7, discussed below). An initial electronic display image containing a first menu 304, shown in FIG. 3, can be automatically presented to the user in response to selection of the wizard menu option 302 in FIG. 2. This menu 304 can include an option to add a new sentence 306.

As shown in item 104 in FIG. 1, such methods automatically provide, from the processor to the display device, an electronic display image containing the first wizard question page, in response to the selection of the wizard menu option (item 102). As shown in FIG. 4, this wizard question page only displays a menu of colors 310 on the display device 212. The menu of colors 310 includes text 312 asking the user what color to change, a partially formed natural language sentence 314, user-selectable icons of different colors 316, color expansion user-selectable icons 318, a cancel button 336, etc. The partially formed natural language sentence 314 can display a previously created natural language sentence, if the wizard is in edit mode, as described in greater detail below.

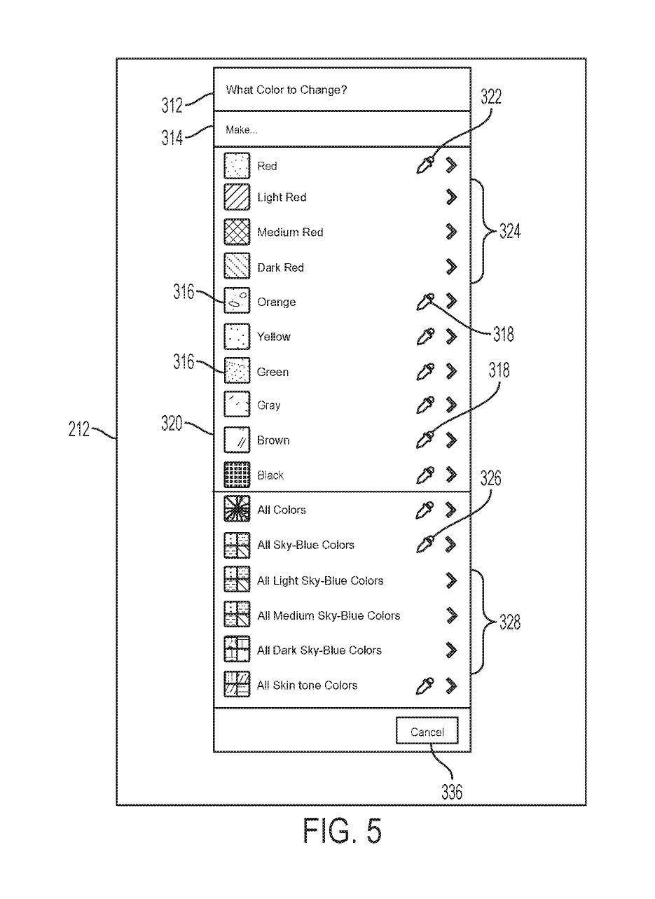

The color expansion option icons 318 allow the initial color icons 316 to be expanded to display sub-color icons, shown in FIG. 5. Therefore, as shown in FIGS. 1, 4, and 5, in response to the selection of a color expansion option 318 for a color 316 from the menu of colors (in item 106, FIG. 1) the processor can optionally automatically create a second modified menu of colors (320, FIG. 5) in item 108 (FIG. 1) by expanding the first menu of colors 310 (FIG. 4) to include sub-colors (324, 328, FIG. 5) of the expanded color, in addition to color choices provided within the first menu of colors 310. The modified menu of colors (320, FIG. 5) is automatically displayed as the second wizard question page, as shown in item 110 in FIG. 1.

More specifically, as shown in FIG. 5, when the color expansion option icon 322 for red is selected by the user interacting with the menu of colors 310 displayed in the user interface 212, additional sub-color icons 324 (light red, medium red, dark red, etc.) are shown in the modified menu of colors 320. Similarly, when the color expansion option icon 326 for all sky-blue colors is selected by the user interacting with the menu of colors 310, additional sub-color icons 328 (all light sky-blue colors, all medium sky-blue colors, all dark sky-blue colors, etc.) are shown in the modified menu of colors 320. Thus, in item 110, the processor can provide to the display device 212, an electronic display image having a second wizard question page that only displays the modified menu of colors 320, in response to selection of the color expansion options 322, 326 from the first menu of colors 310.

The user-selectable color icons 316 correspond to a range of more specifically defined colors within a color space (such as RGB (red, green, blue), Lab (CIELAB (or L*a*b*), YUV (luma (Y′) and chrominance (UV)), YCrCb (Y′ is the luma component, and CB and CR are the blue-difference and red-difference chroma components), CMYK (cyan, magenta, yellow, black, etc.), etc.); and the user-selectable sub-color icons 324, 328 correspond to a relatively more narrow range within the range of the color that the sub-colors fall within. Further, the color names of the icons 316, 324, 328 are selected to match what most users would consider that color name to mean, and the icons each have a distinct color that approximates the corresponding a range of more specifically defined colors of the color space.

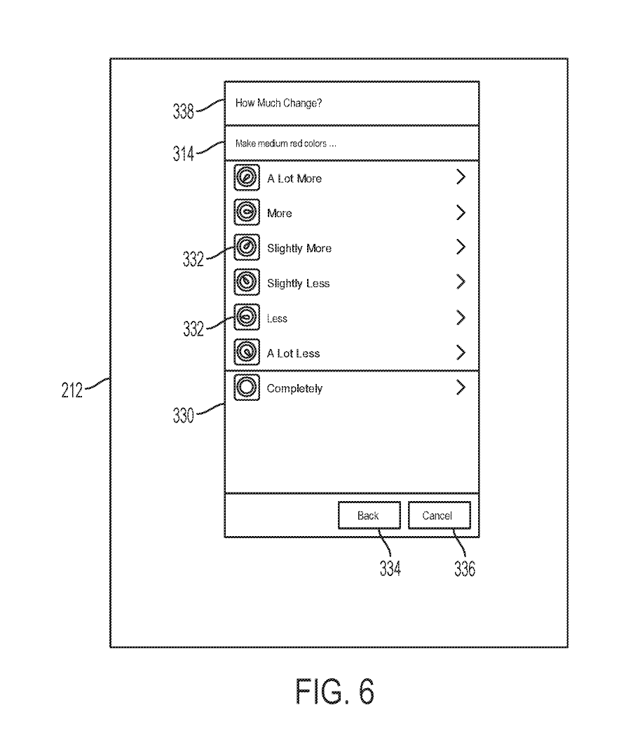

As shown in FIG. 1, in response to selection of a color or sub-color option (item 112) from the first menu of colors 310 or the second modified menu of colors 320, in item 114 the processor can automatically supply an electronic display image having a third wizard question page to the display device 212. As shown in FIG. 6, the third wizard question page only displays a menu of change magnitude and change orientation phrases (e.g., more, slightly more, less, etc.) 330, which is sometimes referred to as a magnitude/orientation change menu 330. This magnitude/orientation change menu 330 includes user-selectable icons 332 having phrases that represent different magnitudes of change (a lot, slight, etc.), as well as orientations of change (more, less), a back button 334 to return to the previous menu (FIGS. 3 and 4), text asking the user how much change to make 338, etc.

Note that in the example shown in FIG. 6, the user selected the color “medium red” option from the modified menu of colors 320, resulting in the partially formed natural language sentence 314 being more fully completed (relative to the level of sentence completion shown in FIG. 5). This occurs by the processors adding the words of the selected color (“medium red”) between the words “Make” and “colors” to form the partial sentence “Make medium red colors . . . .”

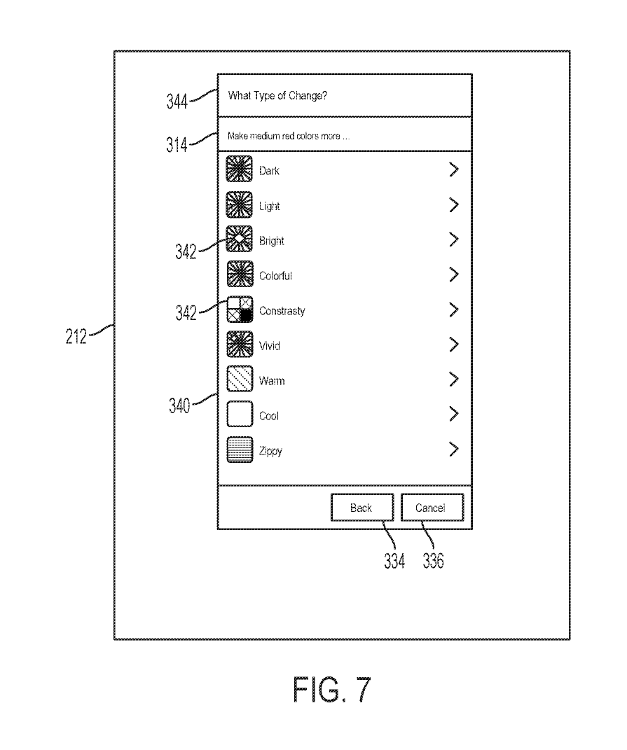

Then, as shown in item 116 in FIG. 1, the user interacts with the user interface 212 shown in FIG. 6 to provide a selection of a change magnitude and change orientation phrase menu option 332. In response to the magnitude/orientation change menu option in item 116, the processor automatically provides to the display device, an electronic display image having another (e.g., a fourth) wizard question page (shown in FIG. 7) in item 118. This fourth wizard question page only displays a menu of color characteristic terms 340 that includes user-selectable icons 342 having phrases that represent different color characteristics, such as light, vivid, warm, etc.; text asking the user what type of change to make 344, etc.

Note that in the example shown in FIG. 7, the user selected the magnitude/orientation change menu option “more” from the magnitude/orientation change menu 330, resulting in the partially formed natural language sentence 314 being more fully completed (relative to the level of sentence completion shown in FIG. 6). This occurs because the processors adds the word of the selected magnitude/orientation change menu option (“more”) to the end of the partially formed natural language sentence “Make medium red colors” shown in FIG. 6 to result in the more complete partially formed natural language sentence “Make medium red colors more . . . .”

Then, as shown in item 120 in FIG. 1, the user interacts with the user interface 212 shown in FIG. 7 to provide a selection of a color characteristic by selecting one of the user-selectable icons 342. This allows the processor to automatically create (or, more accurately automatically complete) the natural language sentence in item 122 by combining the selected color, the selected change magnitude and change orientation phrase, and the selected color characteristic term. For example, if the color characteristic 342 “vivid” was selected from the menu in FIG. 7, this completes the partially formed natural language sentence to “Make medium red colors more vivid.”

Thus, as shown above, to aid the user in making color changes to items that will be printed or displayed, the methods and devices herein allow the user to enter the color changes using natural language sentences. However, even with this option, users may not understand how to create or edit such natural language sentences, or users may form illogical or vague sentences, or use terms that are not understandable by the print driver. For example, users may form sentences lacking verbs, lacking adverbs, placing nouns and verbs in the incorrect order in the sentence, etc.

Therefore, the methods and devices herein help the user form a properly worded and properly structured natural language sentence, by only presenting a limited list of words and/or phrases that are acceptable to, and understandable by, the print driver in the menus. Additionally, the wizard only presents such menus of sentence elements to the user in a specific order so that when the acceptable words and/or phrases are combined, they form a properly structured sentence.

More specifically, as shown above, the wizard question pages 310, 320, 330, 340, only include words and/or phrases that are acceptable to, and understandable by, the print driver; which prevents users from entering words or phrases that are not understood by the print driver. Further, the wizard fixes some of the words in the sentence (e.g., in this example, the first word (the verb) of the sentence (in this example “Make”) is fixed) and the noun “colors” is fixed. Menus 310 and 320 are displayed by themselves (alone on the display) and before the other menus 330 and 340, to force the user to add a color (e.g., an adjective of noun colors, in this exemplary sentence) after the fixed verb “Make.” Next, with a verb, adjective, and noun in place, menu 330 is presented to add an adverb (e.g., “slightly more” in this example); and after the adverb is submitted, menu 340 is presented to complete the sentence by adding an adjective (“vivid”). Thus, by restricting the words, and the order of the words, the sentence is prepared in a manner that is acceptable and understandable to the print driver, yet still in the easily user-understood form of a natural language sentence. Further, by only presenting a single menu to the user at a time (each menu is presented by itself (one menu at a time)) potential user confusion and frustration is reduced, thereby increasing user satisfaction.

In response to the natural language sentence being created/completed in item 122, in these methods the processor alters the color item (e.g., alters the image, document, etc.) being output (e.g., printed, displayed, etc.) in item 124 by automatically changing locations (e.g., pixels, document areas) of the color item that have the selected color described in the natural language sentence, and such item locations are changed as instructed by the selected change magnitude and change orientation phrase, and the color characteristic term. In other words, in item 124, if the completed natural language sentence is: “Make medium red colors more vivid.”; the processor will increase the vividness of pixels or document areas of the color item that are of a medium red color. Eventually, the item is automatically output by display, printing, etc., as shown in item 126.

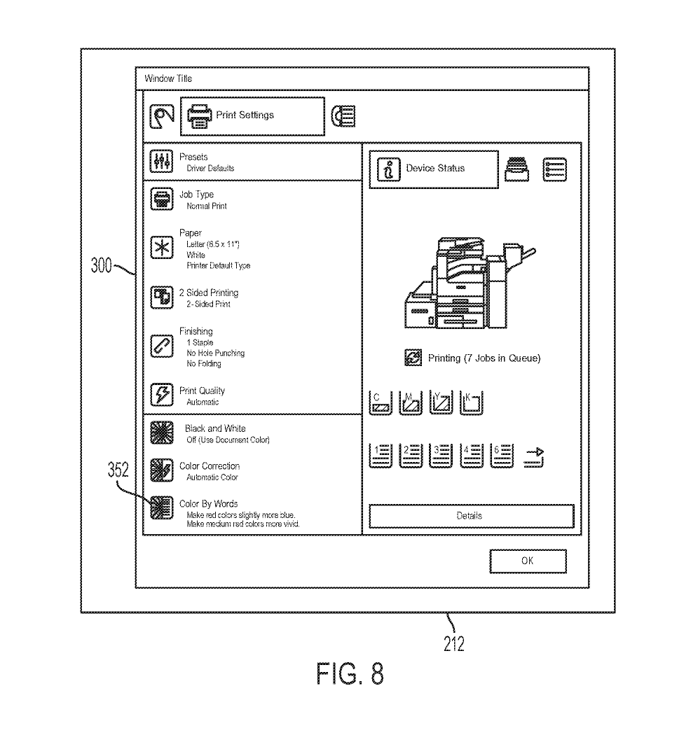

The wizard used in methods and systems herein can also allow the user to edit a previously created natural language sentence. This is shown in FIG. 8, which is similar to FIG. 2, described above, except that the wizard menu option 352 now shows some previously created natural language sentences (e.g., “Make red colors slightly more blue.” and “Make medium red colors more vivid.”).

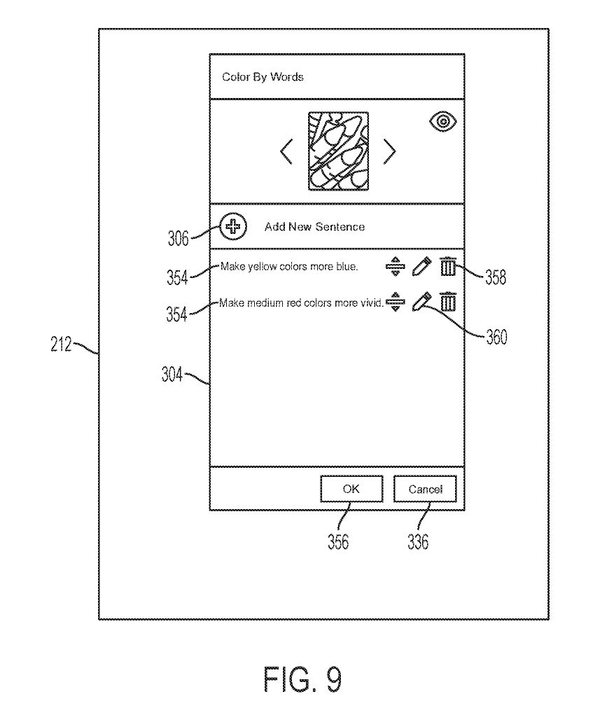

User selection of the wizard menu option 352 in FIG. 8 causes the processor to display a revised menu 304 in FIG. 9, which is substantially similar to the menu 304 shown in FIG. 3, except for the addition of the existing natural language sentences 354, adjacent to which appear delete icons 358 and edit icons 360. Selection of the delete icon 358 in FIG. 9 deletes the natural language sentence to which it is adjacent.

In addition an “OK” button 356 is included within the menu 304 in FIG. 9. Selection of the “OK” button 356 causes the highlighted natural language sentence to be applied to the item before output (without needing to proceed through the 1^{st}-4^{th} wizard question pages shown in FIGS. 4-7, discussed above). To the contrary, selection of the edit icon 360 walks to users through the 1^{st}-4^{th} wizard question pages shown in FIGS. 4-7 to allow the user to edit the existing natural language sentence. When editing a previously existing natural language sentence, rather than displaying the partially formed natural language sentence 314; instead the constantly revised edited natural language sentence is displayed to the user during the questioning process performed through FIGS. 4-7.

The hardware described herein plays a significant part in permitting the foregoing method to be performed, rather than function solely as a mechanism for permitting a solution to be achieved more quickly, (i.e., through the utilization of a computer for performing calculations).

As would be understood by one ordinarily skilled in the art, the processes described herein cannot be performed by a human alone (or one operating with a pen and a pad of paper) and instead such processes can only be performed by a machine (especially when the electronic display, automated processing, and altering of a color item being output is considered). Specifically, processes such as displaying electronic data streams, altering electronic items that are being displayed or printed, using printers and display devices, etc., requires the utilization of different specialized machines, and humans cannot perform such processing without machines. Further, such machine-only processes are not mere “post-solution activity” because the methods herein involve electronic graphic user interface interaction. In other words, these various machines are integral with the methods herein because the methods cannot be performed without the machines (and cannot be performed by humans alone).

Additionally, the methods herein solve many highly complex technological problems. For example, as mentioned above, users are often confused about how to form natural language sentences that change how color items are output. Methods herein solve this technological problem by individually walking the users through each decision point when forming the natural language sentence, using helpful and graphically driven display interactive tools. This reduces the amount of mistakes a user may generate when creating or editing a natural language sentence, and increase user satisfaction by simplifying the process for the user. By granting such benefits to printing drivers, the methods herein reduce the amount of errors generated, thereby solving a substantial technological problem that providers experience today.

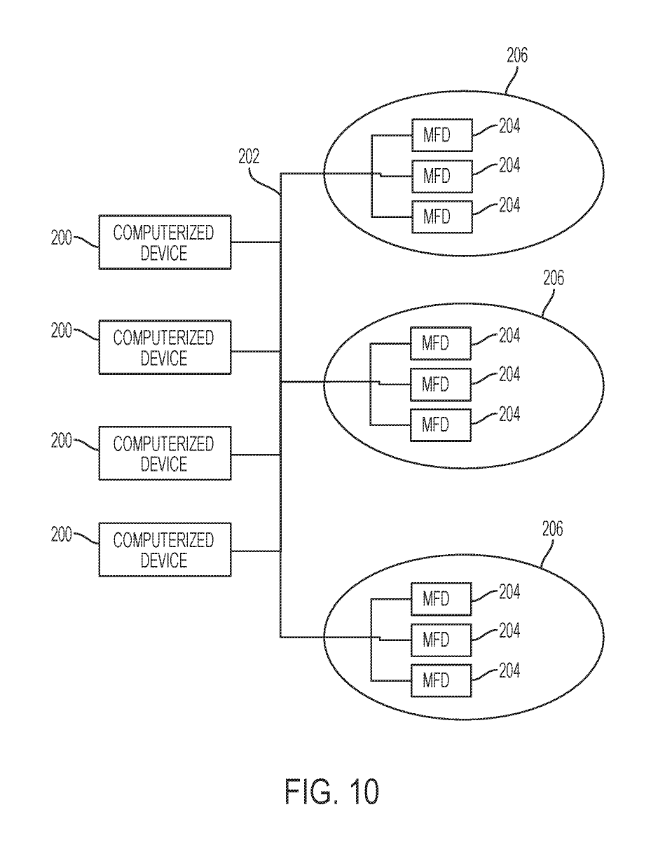

As shown in FIG. 10, exemplary systems and methods herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

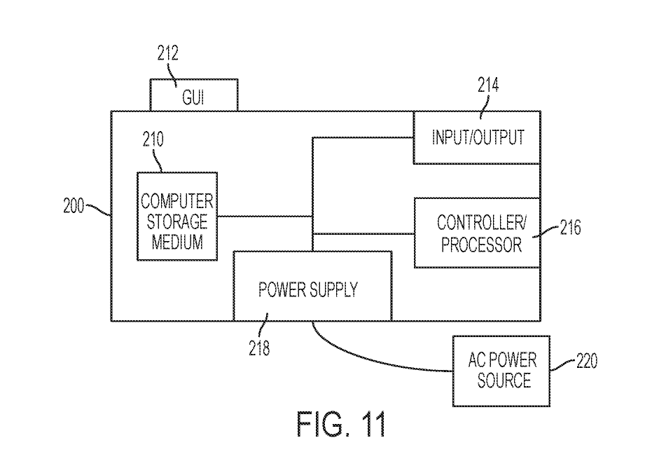

FIG. 11 illustrates a computerized device 200, which can be used with systems and methods herein and can comprise, for example, a print server, a personal computer, a portable computing device, etc. The computerized device 200 includes a controller/tangible processor 216 and a communications port (input/output) 214 operatively connected to the tangible processor 216 and to the computerized network 202 external to the computerized device 200. Also, the computerized device 200 can include at least one accessory functional component, such as a graphical user interface (GUI) assembly 212. The user may receive messages, instructions, and menu options from, and enter instructions through, the graphical user interface or control panel 212.

The input/output device 214 is used for communications to and from the computerized device 200 and comprises a wired device or wireless device (of any form, whether currently known or developed in the future). The tangible processor 216 controls the various actions of the computerized device. A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device to perform its various functions, such as those described herein. Thus, as shown in FIG. 11, a body housing has one or more functional components that operate on power supplied from an alternating current (AC) source 220 by the power supply 218. The power supply 218 can comprise a common power conversion unit, power storage element (e.g., a battery, etc), etc.

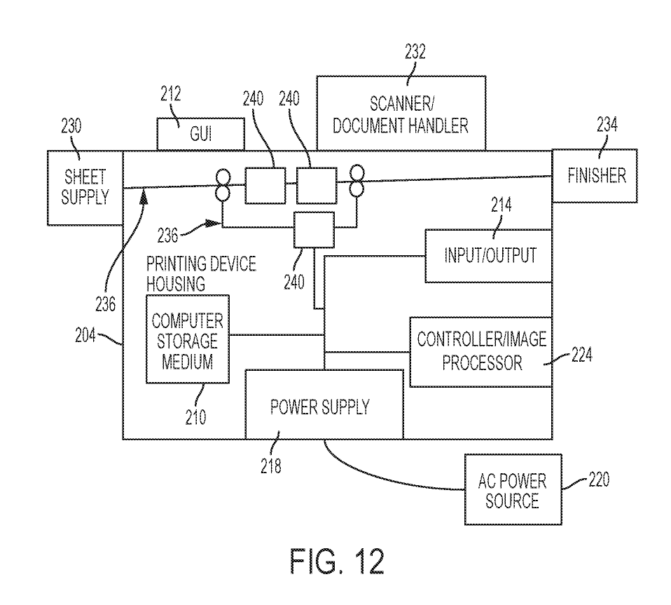

FIG. 12 illustrates a computerized device that is a printing device 204, which can be used with systems and methods herein and can comprise, for example, a printer, copier, multi-function machine, multi-function device (MFD), etc. The printing device 204 includes many of the components mentioned above and at least one marking device (printing engine(s)) 240 operatively connected to a specialized image processor 224 (that is different than a general purpose computer because it is specialized for processing image data), a media path 236 positioned to supply continuous media or sheets of media from a sheet supply 230 to the marking device(s) 240, etc. After receiving various markings from the printing engine(s) 240, the sheets of media can optionally pass to a finisher 234 which can fold, staple, sort, etc., the various printed sheets. Also, the printing device 204 can include at least one accessory functional component (such as a scanner/document handler 232 (automatic document feeder (ADF)), etc.) that also operate on the power supplied from the external power source 220 (through the power supply 218).

The one or more printing engines 240 are intended to illustrate any marking device that applies a marking material (toner, inks, etc.) to continuous media or sheets of media, whether currently known or developed in the future and can include, for example, devices that use a photoreceptor belt or an intermediate transfer belt, or devices that print directly to print media (e.g., inkjet printers, ribbon-based contact printers, etc.).

Therefore, devices 200/204 and systems (FIG. 10) herein include, among other elements and components, a processor 216/224, a display device 212 electrically connected to the processor 216/224 (e.g., a user interface having an electronic display, and user input devices and features (touch screen, mouse, buttons, etc.)), a printer 240 electrically connected to the processor 216/224, etc. The processor 216/224 provides, to the display device 212, an electronic display image having a wizard menu option to begin a natural language wizard. The natural language wizard generates a natural language sentence indicating an intended color change by combining responses to wizard question pages.

The processor 216/224 provides, to the display device 212, an electronic display image having a first wizard question page, in response to selection of the wizard menu option. The first wizard question page only displays a first menu of colors. The processor 216/224 creates, in response to selection of an expanded color from the first menu of colors, a modified menu of colors by expanding the first menu of colors to include sub-colors of the expanded color in addition to color choices provided within the first menu of colors. Also, the processor 216/224 provides, to the display device 212, an electronic display image having a second wizard question page, in response to selection of the expanded color from the first menu of color. The second wizard question page only displays the modified menu of colors.

Additionally, the processor 216/224 provides, to the display device 212, an electronic display image having a third wizard question page in response to selection of a selected color from the modified menu of colors. The third wizard question page only displays a menu of change magnitude and change orientation phrases. The processor 216/224 further provides, to the display device 212, an electronic display image having a fourth wizard question page in response to selection of a change magnitude and change orientation phrase from the menu of change magnitude and change orientation phrases. The fourth wizard question page only displays a menu of color characteristic terms.

In turn, the processor 216/224 creates, in response to selection of a color characteristic term from the menu of color characteristic terms, the natural language sentence by combining the selected color, the change magnitude and change orientation phrase, and the color characteristic term. The processor 216/224 alters, in response to the natural language sentence, outputting (e.g., printing, display, etc.) of a color item performed by the printer 240 by changing pixels of the color item that have the selected color according to the change magnitude and change orientation phrase, and the color characteristic term.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, printers, copiers, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

Further, the terms automated or automatically mean that once a process is started (by a machine or a user), one or more machines perform the process without further input from any user. In the drawings herein, the same identification numeral identifies the same or similar item. It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
providing an electronic display image having a wizard menu option to begin a natural language wizard;
providing an electronic display image having a first wizard question page in response to selection of said wizard menu option, said first wizard question page displays only a menu of colors;
providing an electronic display image having a second wizard question page in response to selection of a selected color from said menu of colors, said second wizard question page displays only a menu of change magnitude and change orientation phrases;
providing an electronic display image having a third wizard question page in response to selection of a change magnitude and change orientation phrase from said menu of change magnitude and change orientation phrases, said third wizard question page displays only a menu of color characteristic terms;
creating, in response to selection of a color characteristic term from said menu of color characteristic terms, a natural language sentence by combining said selected color, said change magnitude and change orientation phrase, and said color characteristic term; and
altering, in response to said natural language sentence, a color item by changing locations of said color item that have said selected color according to said change magnitude and change orientation phrase, and said color characteristic term.

2. The method according to claim 1, said menu of colors includes text asking what color to change,
said menu of change magnitude and change orientation phrases includes text asking how much change, and
said menu of color characteristic terms includes text asking what type of change.

3. The method according to claim 1, said menu of colors includes icons of different colors,
said menu of change magnitude and change orientation phrases includes icons of change and orientation, and
said menu of color characteristic terms includes icons for types of changes.

4. The method according to claim 1, wizard menu option comprises a first menu option to create said natural language sentence, and a modified menu option to edit said natural language sentence.

5. The method according to claim 1, said menu of colors, said menu of change magnitude and change orientation phrases, and said menu of change magnitude and change orientation phrases include back and cancel buttons.

6. The method according to claim 1, said providing said wizard menu option displays said wizard menu option in a document printing menu.

7. A method comprising:
providing, from a processor to a display device, an electronic display image having a wizard menu option to begin a natural language wizard,
said natural language wizard generates a natural language sentence indicating an intended color change by combining responses to wizard question pages;
providing, from said processor to said display device, an electronic display image having a first wizard question page, of said wizard question pages, in response to selection of said wizard menu option,
said first wizard question page displays only a first menu of colors;
creating, by said processor, in response to selection of an expanded color from said first menu of colors, a modified menu of colors by expanding said first menu of colors to include sub-colors of said expanded color in addition to color choices provided within said first menu of colors;
providing, from said processor to said display device, an electronic display image having a second wizard question page, of said wizard question pages, in response to selection of said expanded color from said first menu of colors,
said second wizard question page displays only said modified menu of colors;
providing, from said processor to said display device, an electronic display image having a third wizard question page, of said wizard question pages, in response to selection of a selected color from said modified menu of colors,
said third wizard question page displays only a menu of change magnitude and change orientation phrases;
providing, from said processor to said display device, an electronic display image having a fourth wizard question page, of said wizard question pages, in response to selection of a change magnitude and change orientation phrase from said menu of change magnitude and change orientation phrases,
said fourth wizard question page displays only a menu of color characteristic terms;
creating, by said processor, in response to selection of a color characteristic term from said menu of color characteristic terms, said natural language sentence by combining said selected color, said change magnitude and change orientation phrase, and said color characteristic term; and
altering, by said processor, in response to said natural language sentence, printing of a color item by changing pixels of said color item that have said selected color according to said change magnitude and change orientation phrase, and said color characteristic term.

8. The method according to claim 7, said first menu of colors and said modified menu of colors include text asking what color to change,
said menu of change magnitude and change orientation phrases includes text asking how much change, and
said menu of color characteristic terms includes text asking what type of change.

9. The method according to claim 7, said first menu of colors and said modified menu of colors include icons of different colors,
said menu of change magnitude and change orientation phrases includes icons of change and orientation, and
said menu of color characteristic terms includes icons for types of changes.

10. The method according to claim 7, said wizard menu option comprises a first menu option to create said natural language sentence, and a modified menu option to edit said natural language sentence.

11. The method according to claim 7, said first menu of colors, said modified menu of colors, said menu of change magnitude and change orientation phrases, and said menu of change magnitude and change orientation phrases include back and cancel buttons.

12. The method according to claim 7, said providing said wizard menu option displays said wizard menu option in a document printing menu.

13. The method according to claim 7, said display device comprising a user interface having an electronic display and user input devices and features.

14. A device comprising:
a processor;
a display device electrically connected to said processor; and
a printer electrically connected to said processor,
said processor provides, to said display device, an electronic display image having a wizard menu option to begin a natural language wizard,
said natural language wizard generates a natural language sentence indicating an intended color change by combining responses to wizard question pages,
said processor provides, to said display device, an electronic display image having a first wizard question page, of said wizard question pages, in response to selection of said wizard menu option,
said first wizard question page displays only a first menu of colors,
said processor creates, in response to selection of an expanded color from said first menu of colors, a modified menu of colors by expanding said first menu of colors to include sub-colors of said expanded color in addition to color choices provided within said first menu of colors,
said processor provides, to said display device, an electronic display image having a second wizard question page, of said wizard question pages, in response to selection of said expanded color from said first menu of colors,
said second wizard question page displays only said modified menu of colors,
said processor provides, to said display device, an electronic display image having a third wizard question page, of said wizard question pages, in response to selection of a selected color from said modified menu of colors,
said third wizard question page displays only a menu of change magnitude and change orientation phrases,
said processor provides, to said display device, an electronic display image having a fourth wizard question page, of said wizard question pages, in response to selection of a change magnitude and change orientation phrase from said menu of change magnitude and change orientation phrases,
said fourth wizard question page displays only a menu of color characteristic terms,
said processor creates, in response to selection of a color characteristic term from said menu of color characteristic terms, said natural language sentence by combining said selected color, said change magnitude and change orientation phrase, and said color characteristic term, and
said processor alters, in response to said natural language sentence, printing of a color item performed by said printer by changing pixels of said color item that have said selected color according to said change magnitude and change orientation phrase, and said color characteristic term.

15. The device according to claim 14, said first menu of colors and said modified menu of colors include text asking what color to change,
said menu of change magnitude and change orientation phrases includes text asking how much change, and
said menu of color characteristic terms includes text asking what type of change.

16. The device according to claim 14, said first menu of colors and said modified menu of colors include icons of different colors,
said menu of change magnitude and change orientation phrases includes icons of change and orientation, and
said menu of color characteristic terms includes icons for types of changes.

17. The device according to claim 14, said wizard menu option comprises a first menu option to create said natural language sentence, and a modified menu option to edit said natural language sentence.

18. The device according to claim 14, said first menu of colors, said modified menu of colors, said menu of change magnitude and change orientation phrases, and said menu of change magnitude and change orientation phrases include back and cancel buttons.

19. The device according to claim 14, said display device displays said wizard menu option in a document printing menu.

20. The device according to claim 14, said display device comprising a user interface having an electronic display and user input devices and features.
